(19) United States
(12) Patent Application Publication
(10) Pub. No.: US 2026/0064338 A1
(43) Pub. Date: Mar. 5, 2026

(54) INFORMATION PROCESSING APPARATUS, METHOD FOR CONTROLLING INFORMATION PROCESSING APPARATUS, AND STORAGE MEDIUM

(71) Applicant: CANON KABUSHIKI KAISHA, Tokyo (JP)

(72) Inventor: REO TAGAWA, Tokyo (JP)

(21) Appl. No.: 19/305,075

(22) Filed: Aug. 20, 2025

(30) Foreign Application Priority Data
Aug. 29, 2024 (JP) 2024-147961

(51) Int. Cl. G06F 3/12; G06T 3/60; G06T 7/00

(52) U.S. Cl. CPC G06F 3/1256; G06F 3/1208; G06T 3/60; G06T 7/0008; G06T 2207/30144; G06T 2207/30168

(57) ABSTRACT

An information processing apparatus is caused to function as a notification unit configured to notify an application of margin information obtained by rotating margins applied to manuscript data by 180 degrees, based on a first condition; an obtaining unit configured to obtain first image data obtained by applying the margin information to the manuscript data generated by the application; a display control unit configured to rotate the first image data by 180 degrees based on the first condition and to display the data as second image data on a preview screen; and a rotation control unit configured to rotate a printable area of the displayed second image data by 180 degrees based on a second condition in the preview screen.

### BACKGROUND

### Field of the Technology

The present disclosure relates to an information processing apparatus, a method for controlling an information processing apparatus, and a storage medium.

### Description of the Related Art

In a case of printing with a printer on a medium with a flap, such as an envelope, some printers require the side with the flap not to be set at the sheet feeding port side to reduce clogging inside the printer. Media with flaps can only be loaded in a limited direction, and thus the loading direction may differ from other media.

In a case of printing with a printer on a medium with a flap, a user may want to position the flap in a desired direction. For example, in a case of landscape mode printing on a long envelope, there are cases where the user wants to have the flap positioned on the left or on the right.

As mentioned above, there is print data generation software having a unit to rotate the print content to accommodate the loading direction of a medium with a flap or to position the flap in a desired direction.

On the other hand, there are cases where a margin (a blank area on the edge of a medium where printing is not performed) is required in printing with a printer. For example, in a case where the top and bottom margins of a medium have different lengths or where the right and left margins have different lengths, rotating the print content using a printer driver leads to a possibility of a positional shift in print content that is not intended by the user or loss of the print content.

Japanese Patent Laid-Open No. 2013-114520 discloses an image forming system including a print setting unit configured to perform print setting for the orientation of a document to be printed on a print medium, and a preview rotating unit configured to rotate a preview of the document independently of the print setting. A method described in Patent Document 1 makes it possible to reduce the possibility of the document being printed in an unintended orientation.

### SUMMARY

A further technology is required to reduce printing results that are not intended by the user.

It is therefore an object of the present disclosure to reduce printing results that are not intended by the user.

A storage medium according to one aspect of the present disclosure is a storage medium storing a program for executing printing using manuscript data generated by an application, which functions in an information processing apparatus and causes the information processing apparatus to function as: a notification unit configured to notify the application of margin information obtained by rotating margins applied to the manuscript data by 180 degrees, based on a first condition; an obtaining unit configured to obtain first image data obtained by applying the margin information to the manuscript data generated by the application; a display control unit configured to rotate the first image data by 180 degrees based on the first condition and to display the first data as second image data on a preview screen; and a rotation control unit configured to rotate a printable area of the displayed second image data by 180 degrees based on a second condition in the preview screen.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram showing an example of a hardware configuration of a print system;

FIG. 2 is a diagram showing an example of a software configuration;

FIG. 3 is a diagram showing an example of a data flow upon execution of printing;

FIG. 4 is a diagram showing a part of GDIINFO;

FIGS. 5A to 5E are diagrams schematically showing drawing contents in each step of the data flow;

FIG. 6 is a diagram showing an example of a print setting screen;

FIG. 7 is a flowchart showing an example of a 180-degree rotation flag setting process;

FIG. 8 is a flowchart showing an example of a GDIINFO setting process;

FIGS. 9A to 9F are diagrams schematically showing drawing contents in each step of the data flow;

FIGS. 10A to 10F are reference diagrams schematically showing drawing contents in each step of the data flow;

FIGS. 11A and 11B are diagrams showing a configuration example of a print preview screen;

FIG. 12 is a flowchart showing an example of print preview processing;

FIG. 13 is a flowchart showing an example of processing for displaying a preview image;

FIG. 14 is a flowchart showing an example of preview image generation processing;

FIG. 15 is a flowchart showing an example of print image generation processing;

FIG. 16 is a flowchart showing an example of print data generation processing;

FIGS. 17A to 17F are diagrams schematically showing drawing contents in each step of a data flow;

FIGS. 18A to 18F are diagrams schematically showing drawing contents in each step of the data flow;

FIGS. 19A to 19F are reference diagrams schematically showing drawing contents in each step of the data flow;

FIGS. 20A to 20C are diagrams showing a configuration example of a print preview screen; and

FIG. 21 is a diagram showing the relationship of FIGS. 21A and 21B; FIG. 21A is a diagram showing an example of print preview processing and FIG. 21B is a diagram showing an example of print preview processing.

### DESCRIPTION OF THE EMBODIMENTS

Preferred embodiments of the present disclosure will be described in detail below with reference to the attached drawings. The following embodiments are not intended to limit the present disclosure according to the claims, and not all combinations of features described in the following embodiments are necessarily essential to the solution of the present disclosure.

### Embodiment 1

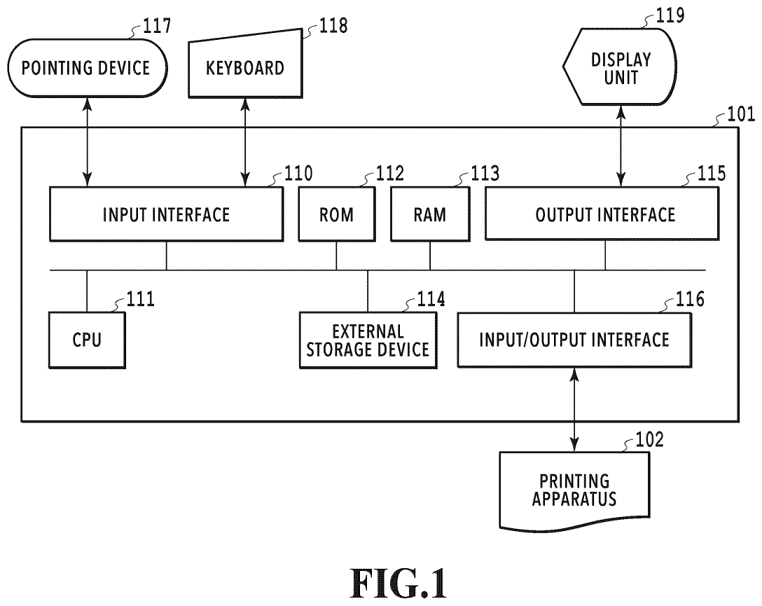

FIG. 1 is a block diagram showing an example of a hardware configuration of a print system. In FIG. 1, a host computer 101 is an example of an information processing apparatus, including an input interface 110, a CPU 111, a ROM 112, a RAM 113, an external storage device 114, an output interface 115, and an input/output interface 116. An input device such as a keyboard 118 or a pointing device 117 is connected to the input interface 110, and a display device such as a display unit 119 is connected to the output interface 115.

The ROM 112 stores an initialization program. The external storage device 114 stores application programs, an OS (operating system), and various other data. The RAM 113 is used as a work memory or the like during execution of various programs stored in the external storage device 114.

In the present embodiment, the CPU 111 performs processing according to the procedures of the program stored in the ROM 112, thereby implementing functions to be described later in the host computer 101 and processing according to flowcharts to be described later. A printing apparatus 102, which is a device, is connected to the host computer 101 via the input/output interface 116. Here, the host computer 101 and the printing apparatus 102 are configured separately, but may be configured as a single information processing apparatus.

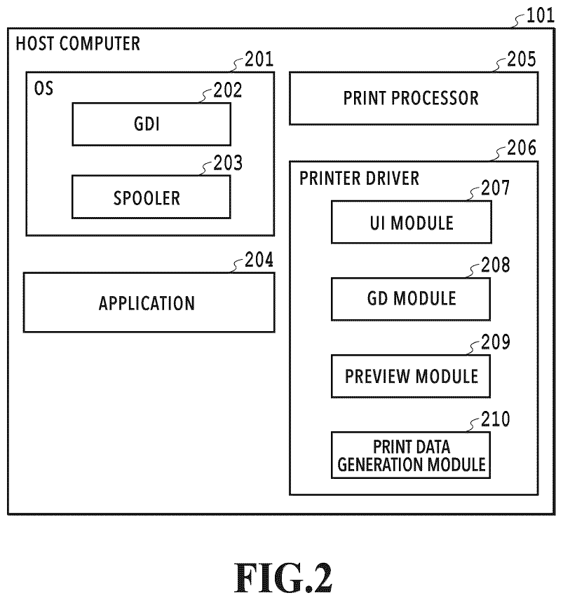

FIG. 2 is a diagram showing an example of a software configuration of the host computer 101 according to the present embodiment. The host computer 101 is composed of the following components or software. An OS 201 performs basic control of the host computer 101. In the present embodiment, the OS 201 uses Windows (registered trademark). The OS 201 includes a graphics device interface (GDI) 202 and a spooler 203. The GDI 202 provides an application programming interface (API) for drawing processing. The spooler 203 is a component for performing processing of generating an EMF spool file 301 to be described later. In the present embodiment, Windows (registered trademark) Spooler is used.

An application 204 is software for performing print setting for a document, image or the like upon instruction from a user, and for issuing a print instruction. A print processor 205 is a component responsible for transmitting a drawing command stored in the EMF spool file 301 to a graphics driver (GD) module 208 to be described later via the GDI 202. The print processor 205 also has a function to start a preview module 209 to be described later.

The printer driver 206 includes a user interface (UI) module 207, the GD module 208, the preview module 209, and a print data generation module 210. The UI module 207 provides an interface for the user to input print settings, and is responsible for transmitting the print settings to the other modules of the printer driver 206. The GD module 208 is responsible for rendering (drawing) processing for printing or has a function to generate print data 304 to be described later. The preview module 209 is responsible for receiving a preview image generated by the GD module and performing display control.

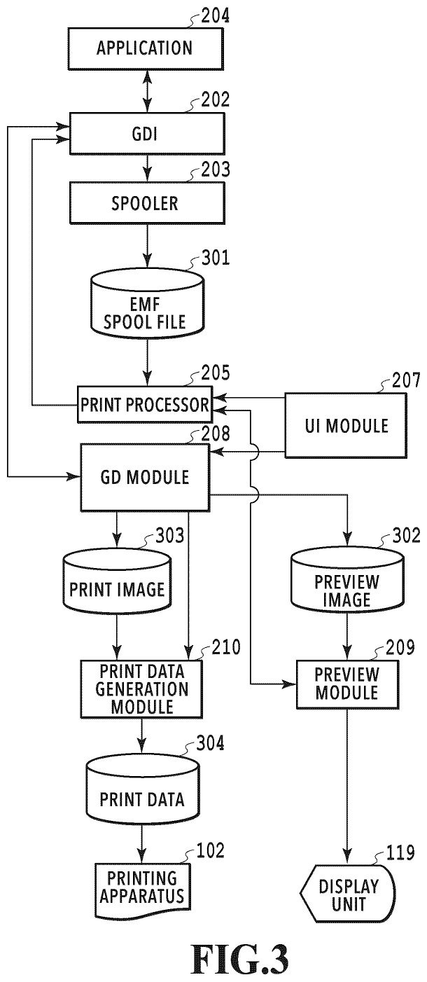

FIG. 3 shows an example of a data flow upon execution of printing from the application 204. The GDI 202 notifies the application 204 of drawing capability information in response to a request from the application 204. The application 204 makes a request, for example, as print settings are made in a print setting screen. The drawing capability information is information having values set by the GD module 208 and stored (set) in a structure called GDIINFO. The GDI 202 notifies the application 204 of the drawing capability information based on the values set in GDIINFO.

Upon receipt of a print instruction from the user through an operation in the print setting screen provided by the UI module 207, the application 204 passes the print settings and drawing data to the GDI 202. The UI module 207 also stores setting values of print setting items in the external storage device 114 or the RAM 113. The drawing data is passed to the GDI 202 with coordinates or size applied based on the drawing capability information. That is, the application 204 generates drawing data (first image data) to which coordinates or size based on margin information, which is a part of the drawing capability information, is applied, and passes the data to the GDI 202. The margin information will be described in detail later.

Upon receipt of the print settings and the drawing data, the GDI 202 uses the spooler 203 to store the print settings and drawing command information in the EMF spool file 301. EMF is an abbreviation for an enhanced metafile, which is a standard method of storing drawing data in Windows (registered trademark). Once the EMF spool file 301 is stored, the spooler 203 loads the print processor 205.

The print processor 205 receives the print settings from the UI module 207. Here, the following processing is performed in a case where a setting for displaying a preview before printing is ON. The print processor 205 instructs to start the preview module 209. The print processor 205 then transmits the drawing command stored in the EMF spool file 301 to the GD module 208 via the GDI 202 to generate an image to be displayed by the preview module 209. In this event, the print processor 205 also informs the GD module 208 that the drawing command will be executed at preview resolution. The GD module 208 generates a preview image 302 based on the received drawing command.

The preview module 209 receives the preview image 302 and performs display control on the display unit 119.

The following processing is performed, on the other hand, in a case where the setting for displaying a preview before printing is OFF upon receipt of the print settings from the UI module 207 by the print processor 205. The print processor 205 transmits the drawing command stored in the EMF spool file 301 to the GD module 208 via the GDI 202. In this event, the print processor 205 also informs the GD module 208 that the drawing command will be executed at printing resolution. The GD module 208 generates a print image 303 based on the received drawing command. Thereafter, the print data generation module 210 generates print data 304 that can be interpreted by the printing apparatus 102, based on the print image 303 and the print settings received from the UI module 207 via the GD module 208. The generated print data 304 is sent to the printing apparatus 102. The printing apparatus 102 interprets the received print data 304 to perform printing on a medium. The processing in the case where the setting for displaying a preview before printing is OFF is the same as processing in a case where the preview module 209 receives a print start instruction after the preview image 302 is displayed.

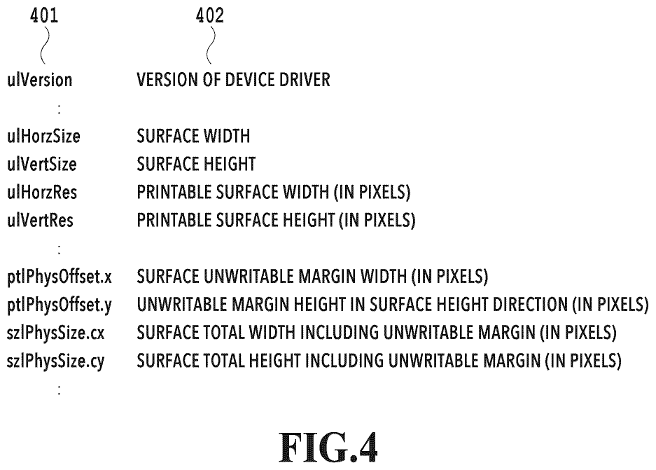

FIG. 4 is a diagram showing a part of GDIINFO. GDIINFO is a structure for storing graphics device drawing capability information and the like. The GDIINFO structure includes a member name 401 and a member description 402.

For example, a member “ulVersion” stores the version of a device driver, “ulHorzSize” stores a surface width, and “ulVertSize” stores a surface height. Positive values are in millimeters, and negative values are in micrometers. “ulHorzRes” represents a printable surface width, and “ulVertRes” represents a printable surface height (both in pixels). “ptlPhysOffset.x” represents a length of an unwritable margin area in the width direction, with the upper left corner of the surface as the origin, and corresponds to the left margin of the medium. The right margin of the medium can be derived by subtracting “ptlPhysOffset.x” from “szlPhysSize.x”, which is the width of the entire surface including the unwritable margin shown in FIG. 4. [0046]“ptlPhysOffset.y” represents a length of an unwritable margin area in the height direction with the upper left corner of the surface as the origin, and corresponds to the top margin of the medium (in pixels). The bottom margin of the medium can be derived by subtracting “ptlPhysOffset.y” from “szlPhysSize.y”, which is the height of the entire surface including the unwritable margin shown in FIG. 4. The information related to the margins among the drawing capability information shown in FIG. 4 is referred to as margin information.

The surface is a virtual screen (drawing target surface) of the graphics device, and the application 204 or the print processor 205 can instruct drawing on the surface via the GDI 202. As described above, the GD module 208 sets a value to GDIINFO, and the GDI 202 notifies the application 204 of the drawing capability information based on the value set to GDIINFO. Then, the application 204 generates drawing data (first image data) to which the margin information, which is part of the drawing capability information, is applied, and passes the data to the GDI 202.

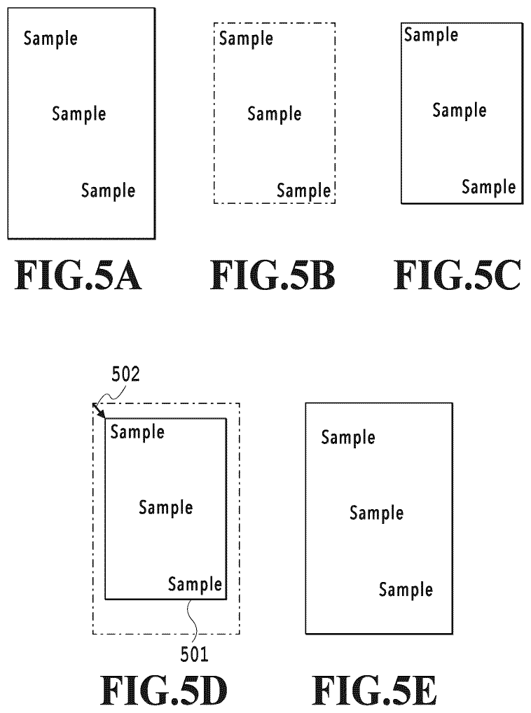

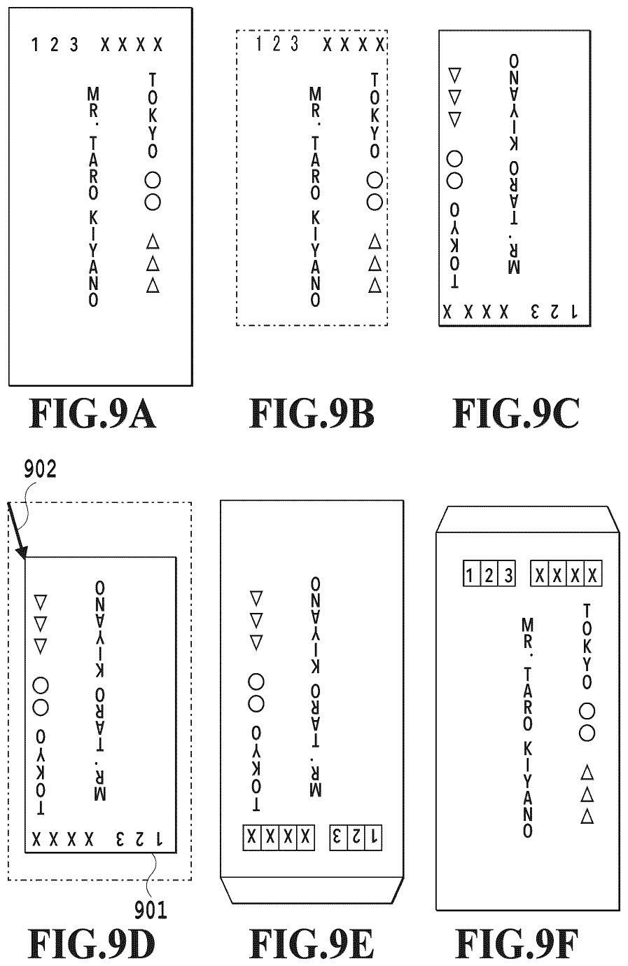

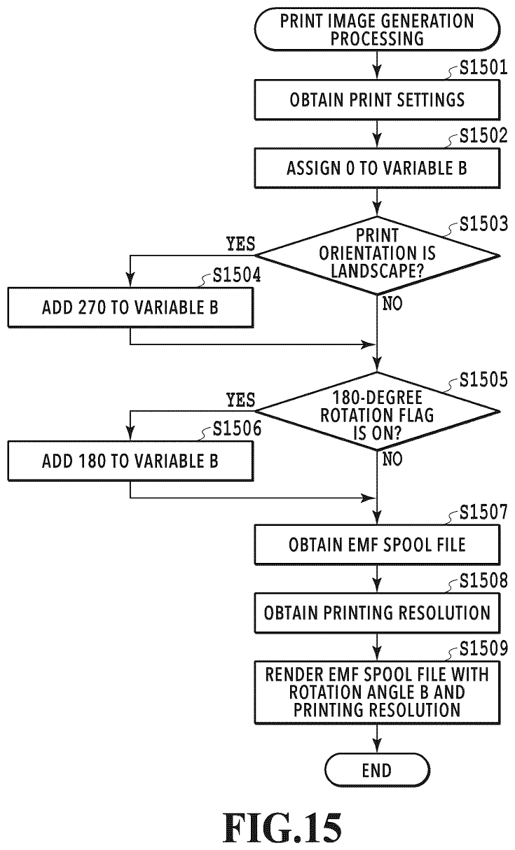

FIGS. 5A to 5E are diagrams schematically showing drawing contents in each process of the data flow described in FIG. 3. FIG. 5A shows manuscript data on the application 204. FIG. 5B shows the EMF spool file 301. The EMF spool file 301 stores drawing information of a printable area, which is an area excluding the margins in the image data. The drawing information is information including the drawing data (first image data) generated by the application 204 and the print settings. Specifically, FIG. 5B shows the printable area to which the margin information in the manuscript data on the application 204 is applied. FIG. 5C shows the print image 303. In the present embodiment, the print image 303 is an image within the printable area. The print image 303 may be rotated by processing of FIG. 15 to be described later, depending on rotation setting in the print settings or information on the type of medium. An example of a case where the print image 303 is rotated will be described later with reference to FIGS. 9A to 9F. FIG. 5D shows print data 304. The print data 304 has at least an image command 501 obtained by converting the print image 303 into a format acceptable by the printing apparatus 102, and a coordinate command 502 for determining a drawing position of the image command 501 on the medium. In the present embodiment, a printing orientation with respect to the medium is such that the sheet feeding port side of the printing apparatus 102 corresponds to the upper side of the image command 501. FIG. 5E shows a printing result formed on the medium by the printing apparatus 102 upon receipt of the print data 304. The relative layout matches between FIGS. 5A and 5E.

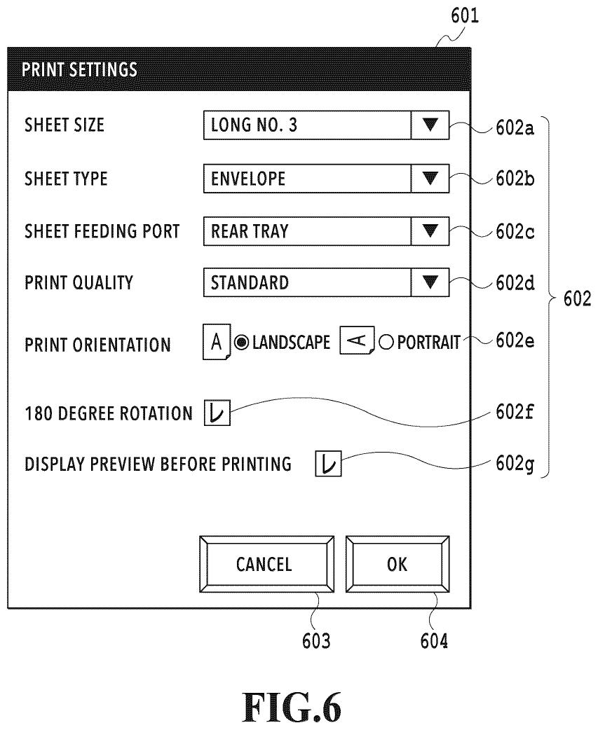

FIG. 6 is a diagram showing an example of a print setting screen. Upon detection of pressing of a print setting button of the application 204 or the OS 201, the CPU 111 instructs the UI module 207 to display the print setting screen on the display unit 119.

By using a print setting window 601, the user can set each setting value of the print setting so as to obtain a desired printing result. The setting value is not limited to a numerical value but also includes a character or a character string and the like. The print setting window 601 has a setting interface 602 that enables setting of the setting value of one or more print setting items. As the setting interface 602, the print setting window 601 has, for example, a sheet size setting interface 602a for setting a sheet size, and a sheet type setting interface 602b for setting a sheet type. The print setting window 601 also has a sheet feeding port setting interface 602c for setting a sheet feeding port, a print quality setting interface 602d for setting print quality, and a print orientation setting interface 602e for setting a print orientation. The print setting window 601 also has a 180-degree rotation setting interface 602f for setting 180-degree rotation printing, and a preview display setting interface 602g for setting whether to display a preview before printing.

The setting values of these print setting items are stored in Windows (registered trademark) DEVMODE structure, and can be referenced by the application 204 or the printer driver 206 and the like. However, the method for storing the setting values of the print setting items is not limited to this method, and information can also be stored in a database called Windows (registered trademark) registry, or a file can be created and stored therein.

The print setting window 601 also has a cancel button 603 and an OK button 604. Upon detection of the user pressing the cancel button 603, the CPU 111 closes the print setting window 601 without saving the items set by the setting interface 602. Upon detection of the user pressing the OK button 604, on the other hand, the CPU 111 instructs the UI module 207 to save the print settings set via the setting interface 602 in the external storage device 114 or the RAM 113. The CPU 111 then closes the print setting window 601. Hereinafter, saving the print settings means recording the setting values of the print setting items in the external storage device 114 or the RAM 113, and obtaining the print settings means reading the setting values of the print setting items saved in the external storage device 114 or the RAM 113. Such a print setting screen is one example, and the print setting items do not have to be those described above, and may include items other than those described above.

Upon detection of the user pressing the OK button 604 in the print setting screen by the CPU 111, a 180-degree rotation flag is stored as one of the print setting items in the present embodiment. The 180-degree rotation flag is a flag for referring to the 180-degree rotation print setting (hereinafter, 180-degree rotation setting) and the selected sheet type or sheet size and eventually determining whether to rotate the print contents 180 degrees. The sheet type that requires the print contents to be rotated 180 degrees is also referred to as an inverse feed medium. The inverse feed medium refers to a sheet that has a flap on the upper side and needs to be set so that the side with the flap is not located on the sheet feeding port side of the printing apparatus. In the present embodiment, since the sheet feeding port side corresponds to the upper side of the image command, the sheet feeding port side is the upper side for media other than the inverse feed medium, but it is assumed that the lower side is the sheet feeding port side for the inverse feed medium with the flap on the upper side. In other words, the print contents need to be rotated 180 degrees in a case of printing on the inverse feed medium.

In a case of rotating the print contents 180 degrees, if the margin information set for the inverse feed medium is not taken into consideration, the print position may be shifted, and the user may not be able to obtain a desired printing result. In the following embodiment, description will be given of a method for reducing a print position shift that is not intended by the user even in a case of printing the rotated print contents by notifying the application 204 of margin information that takes into consideration the rotated printing in a case of rotating the print contents.

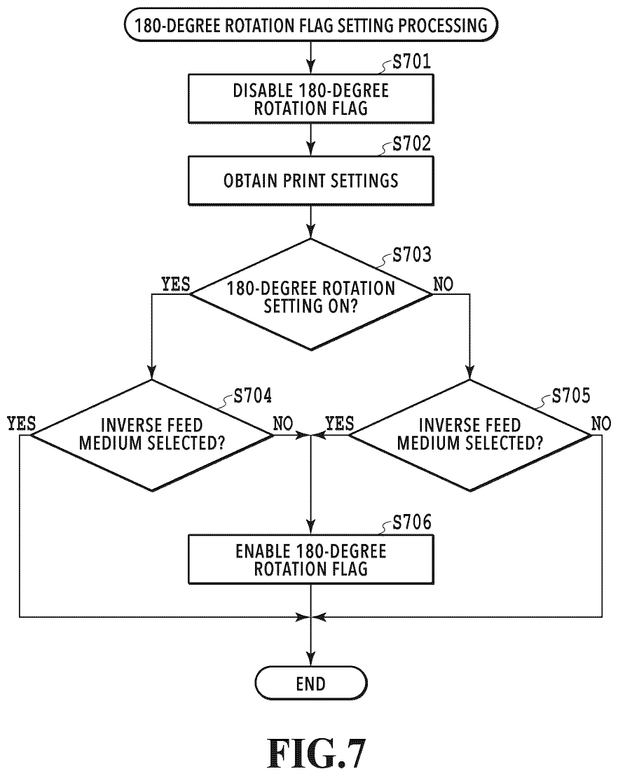

FIG. 7 is a flowchart showing an example of a 180-degree rotation flag setting process in the UI module 207. The process of this flowchart is started after the UI module 207 saves the items set via the setting interface 602. Each process in this flowchart is implemented by the CPU 111 expanding a program stored in the ROM 112 into the RAM 113 and executing the program. Each process in this flowchart is also executed by the CPU 111 functioning as the UI module 207. Therefore, each process is actually performed by the CPU 111, but will be described as being performed by the UI module 207, for ease of understanding. The symbol “S” in the following description of each process indicates a step in the flowchart, and the same applies to the following embodiments.

In S701, the UI module 207 disables the 180-degree rotation flag and saves the flag in print settings. In S702, the UI module 207 obtains the print settings.

In S703, the UI module 207 judges whether the 180-degree rotation setting is ON in the obtained print settings. If it is judged that the 180-degree rotation setting is ON, the UI module 207 proceeds to S704. If it is judged that the 180-degree rotation setting is OFF, the UI module 207 proceeds to S705.

In S704, the UI module 207 judges whether an inverse feed medium is selected in the obtained print settings. If it is judged that the inverse feed medium is selected, the UI module 207 ends the processing of this flowchart. If it is judged that the inverse feed medium is not selected, the UI module 207 proceeds to S706.

In S705, the UI module 207 judges whether the inverse feed medium is selected in the obtained print settings, as in S704. If it is judged that the inverse feed medium is selected, the UI module 207 proceeds to S706. If it is judged that the inverse feed medium is not selected, the UI module 207 ends the processing of this flowchart. In S706, the UI module 207 enables the 180-degree rotation flag, saves the flag in the print settings, and ends the processing of this flowchart.

In the present embodiment, the GDI 202 notifies the application 204 of drawing capability information according to the rotation direction of the print contents. Particularly, in a case where the 180-degree rotation flag is enabled, the application 204 is notified of drawing capability information including margin information after 180-degree rotation. To notify the application 204 of the drawing capability information according to the rotation direction of the print contents, the GD module 208 performs processing to set a GDIINFO value according to the rotation direction.

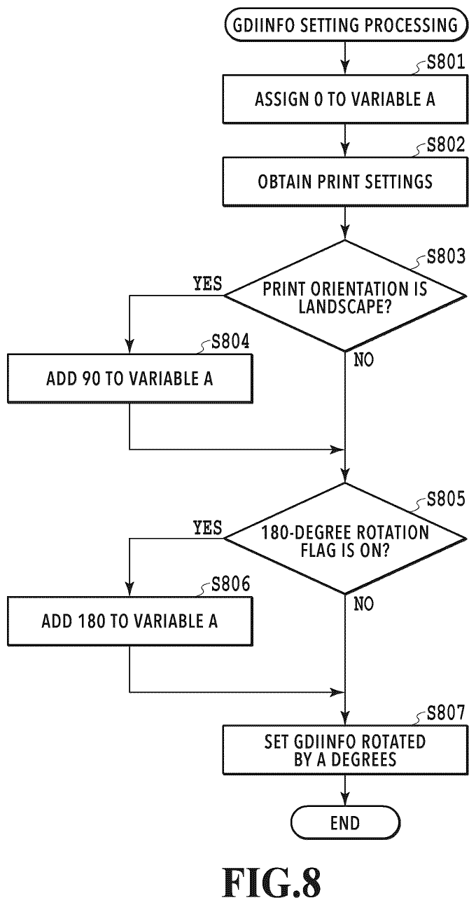

FIG. 8 is a flowchart showing an example of a GDIINFO setting process by the GD module 208. The processing of this flowchart is started by the GDI 202 calling a DrvEnablePDEV function of the GD module 208. The DrvEnablePDEV function is called, for example, as the application 204 requests for the drawing capability information from the GDI 202. Each process in this flowchart is executed by the CPU 111 functioning as the GD module 208. Therefore, each process is actually performed by the CPU 111, but will be described as being performed by the GD module 208, for ease of understanding.

In S801, the GD module 208 assigns 0 to a variable A. The variable is a value used in processing and stored in the external storage device 114 or the RAM 113. In S802, the GD module 208 obtains print settings. In S803, the GD module 208 judges whether the print orientation is landscape in the obtained print settings. If it is judged that the print orientation is landscape, the processing proceeds to S804. If it is judged that the print orientation is not landscape, the GD module 208 proceeds to S805.

In S804, the GD module 208 adds 90 to the variable A. The print orientation can also be changed to landscape by adding 270 to the variable A in this processing. In S805, the GD module 208 judges whether the 180-degree rotation flag is ON in the obtained print settings. If it is judged that the 180-degree rotation flag is ON, the GD module 208 proceeds to S806. If it is judged that the 180-degree rotation flag is OFF, the GD module 208 proceeds to S807.

In S806, the GD module 208 adds 180 to the variable A. In S807, the GD module 208 sets the drawing capability information for rotating counterclockwise by A degrees (the angle of the value of the variable A) in the GDIINFO, and ends the processing of this flowchart. The application 204 stores the drawing command information based on the drawing capability information according to the notified rotation direction in the EMF spool file 301 via the GDI 202.

Here, a method for setting the drawing capability information after rotation in the GDIINFO will be described. A case is considered where, in case of non-rotation, the width of the printable area is 110 mm, the height of the printable area is 205 mm, the top margin is 20 mm, the bottom margin is 10 mm, the left margin is 5 mm, and the right margin is 5 mm. In the present embodiment, the top, bottom, left, and right margins can be set to different lengths depending on the sheet type. In the following description of the present embodiment, these margin lengths are used. These are converted into the number of pixels at 600 dpi. Then, the width of the printable area is 2598 pixels, and the height of the printable area is 4842 pixels. The top margin is 472 pixels, the bottom margin is 236 pixels, the left margin is 118 pixels, and the right margin is 118 pixels.

In a case of no rotation, 2598 (the width of the printable area) is set to “ulHorzRes” and 4842 (the height of the printable area) is set to “ulVertRes”. 118 (left margin) is set to “ptlPhysOffset.x” and 472 (top margin) is set to “ptlPhysOffset.y”.

In a case of counterclockwise 90-degree rotation, 4842 (the height of the printable area) is set to “ulHorzRes” and 2598 (the width of the printable area) is set to “ulVertRes”. 472 (top margin) is set to “ptlPhysOffset.x” and 118 (right margin) is set to “ptlPhysOffset.y”.

In a case of counterclockwise 180-degree rotation, 2598 (the width of the printable area) is set to “ulHorzRes” and 4842 (the height of the printable area) is set to “ulVertRes”. 118 (right margin) is set to “ptlPhysOffset.x” and 236 (bottom margin) is set to “ptlPhysOffset.y”.

In a case of counterclockwise 270-degree rotation, 4842 (the height of the printable area) is set to “ulHorzRes” and 2598 (the width of the printable area) is set to “ulVertRes”. 236 (bottom margin) is set to “ptlPhysOffset.x” and 118 (left margin) is set to “ptlPhysOffset.y”. The values of other GDIINFO members related to the width or height are also set in the same manner.

FIGS. 9A to 9F are diagrams schematically showing drawing contents in each process of the data flow described in FIG. 3. FIGS. 9A to 9F schematically shows the drawing contents in each process of the data flow in a case where the 180-degree rotation setting is OFF, the inverse feed medium is selected, and the print orientation is portrait. A long envelope with a flap on the upper side is used as the medium. The upper side of the long envelope is the side without the flap, and the lower side is the side with the flap. This is because, as described above, printing is performed with the side without the flap facing the sheet feeding port, and in the present embodiment, the sheet feeding port side corresponds to the upper side of the image command. This also applies to description of the top and bottom margins described below.

FIG. 9A shows manuscript data on the application 204. FIG. 9B shows an EMF spool file 301. The EMF spool file 301 stores drawing information of the printable area excluding the margins. In this event, the application 204 is notified of margin information after 180-degree rotation. Therefore, drawing information within the printable area excluding 10 mm on the top (bottom margin in case of non-rotation), 20 mm on the bottom (top margin in case of non-rotation), 5 mm on the left (right margin in case of non-rotation), and 5 mm on the right (left margin in case of non-rotation) is stored. That is, the EMF spool file 301 stores drawing information of the printable area excluding the margins themselves but having the margin information reflected (in the present embodiment, the printable area in a case where the top and bottom margins are reversed). This is because it is considered that the data will be rotated 180 degrees in subsequent processing.

FIG. 9C shows a print image 303, which is rendered based on the EMF spool file 301 in FIG. 9B. The print image 303 is rendered by rotating only the printable area of the data in the EMF spool file 301 based on the print orientation and the 180-degree rotation flag in the print settings. This processing will be described in detail later with reference to FIG. 15. FIG. 9D shows print data 304. As in FIG. 5D, the print data 304 is obtained by converting the print image 303 into a format acceptable by the printing apparatus 102, and has at least an image command 901 and a coordinate command 902 for determining the drawing position of the image command 901 on the medium. The coordinate command 902 is a value based on the margins before rotation. This is because, if the coordinate command 902 is a value based on the margins after rotation, there is a possibility that necessary margins will not be secured for printing with the printing apparatus 102. FIG. 9E shows a printing result formed on the medium by the printing apparatus 102 upon receipt of the print data 304. FIG. 9F shows the printing result rotated 180 degrees from FIG. 9E. The relative layout matches between FIGS. 9A and 9F.

Next, description will be given of what printing result is obtained if the processing of S806 is not performed in FIGS. 9A to 9F (that is, if the margin information in the drawing capability information notified to the application 204 is not rotated 180 degrees).

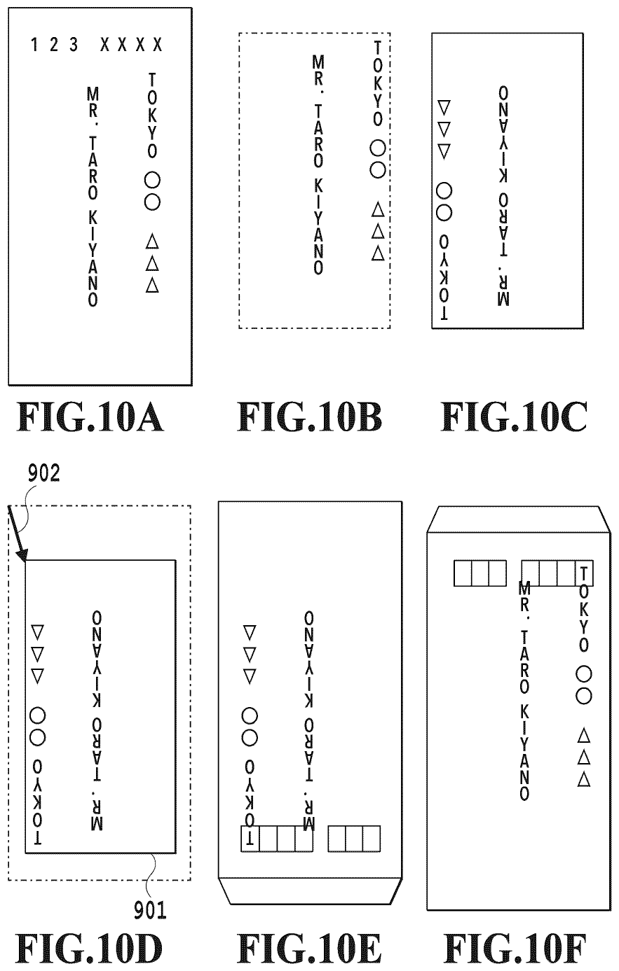

FIGS. 10A to 10F are reference diagrams schematically showing drawing contents in each process of the data flow described in FIG. 3. As mentioned above, FIGS. 10A to 10F. show the same processing as in FIGS. 9A to 9F, except that the processing of S806 in FIG. 8 is not performed.

FIG. 10A shows manuscript data on the application 204. Here, the same manuscript data as in FIG. 9A is used. FIG. 10B shows an EMF spool file 301. The EMF spool file 301 stores drawing information of the printable area excluding the margins. Unlike FIG. 9B, the margin information notified to the application 204 is not rotated. Therefore, drawing information within the printable area excluding 20 mm on the top, 10 mm on the bottom, 5 mm on the left, and 5 mm on the right (each equivalent to the length of the top, bottom, left, and right margins in case of non-rotation) is stored.

FIG. 10C shows a print image 303, which is rendered based on the EMF spool file 301 in FIG. 10B. FIG. 10D shows print data 304. FIG. 10D is the same as FIG. 9D except for the print contents.

FIG. 10E shows a printing result formed on the medium by the printing apparatus 102 upon receipt of the print data 304. FIG. 10F shows the printing result rotated 180 degrees from FIG. 10E. Here, the relative layout does not match between the manuscript data (FIG. 10A) and the printing result (FIG. 10F), and is shifted in the top-bottom direction. This is because a shift occurs by the difference between the top and bottom margins, since the printable area is rotated 180 degrees in the print image 303 (FIG. 10C), but the coordinate command 902 is the value based on the margins before rotation. Similarly, if the left and right margins are different, a shift occurs in the left-right direction. Such a shift in the print contents is caused by processing that is not intended by the user, which is not desirable, but can be reduced by performing the processing of S806 in FIG. 8 described above.

Next, a function to change the 180-degree rotation setting on a print preview will be described.

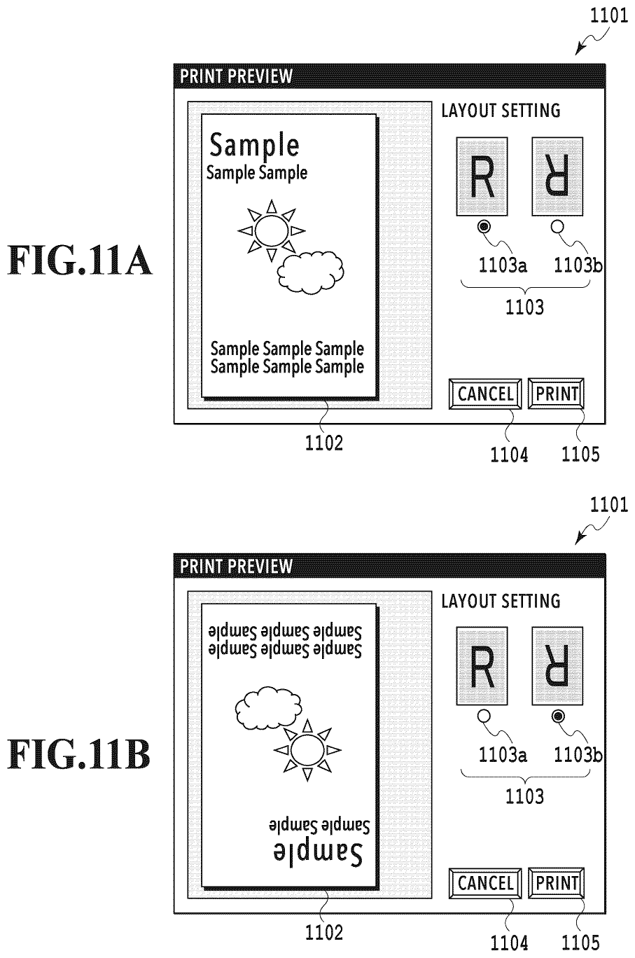

FIGS. 11A and 11B are diagrams showing a configuration example of a print preview screen of the printer driver 206 according to the present embodiment. A print preview screen 1101 displays a preview image 1102 of a printing result. The print preview screen 1101 has a setting interface 1103 for changing the orientation of the print contents. The setting interface 1103 has a 180-degree rotation OFF radio button 1103a and a 180-degree rotation ON radio button 1103b. In a state where the 180-degree rotation OFF radio button 1103a is selected, the preview image 1102 is displayed in a non-rotated state as shown in FIG. 11A. On the other hand, in a state where the 180-degree rotation ON radio button 1103b is selected, the preview image 1102 is displayed in a 180-degree rotated state as shown in FIG. 11B. As for the state where the radio button is pressed while the print preview screen is displayed, the 180-degree rotation flag included in the print settings while the print preview screen is displayed may be referenced, for example, to follow its contents. Specifically, if the 180-degree rotation flag is ON while the print preview screen is displayed, the print preview screen is displayed with the 180-degree rotation ON radio button 1103b pressed. Accordingly, the orientation of the image data displayed in the print preview screen matches the radio button.

The print preview screen 1101 also has a cancel button 1104 and a print button 1105. If the cancel button 1104 is pressed, the print preview screen 1101 is closed and the printer driver 206 ends the processing without generating the print data 304. On the other hand, if the print button 1105 is pressed, the print preview screen 1101 is closed and the printer driver 206 generates the print data 304.

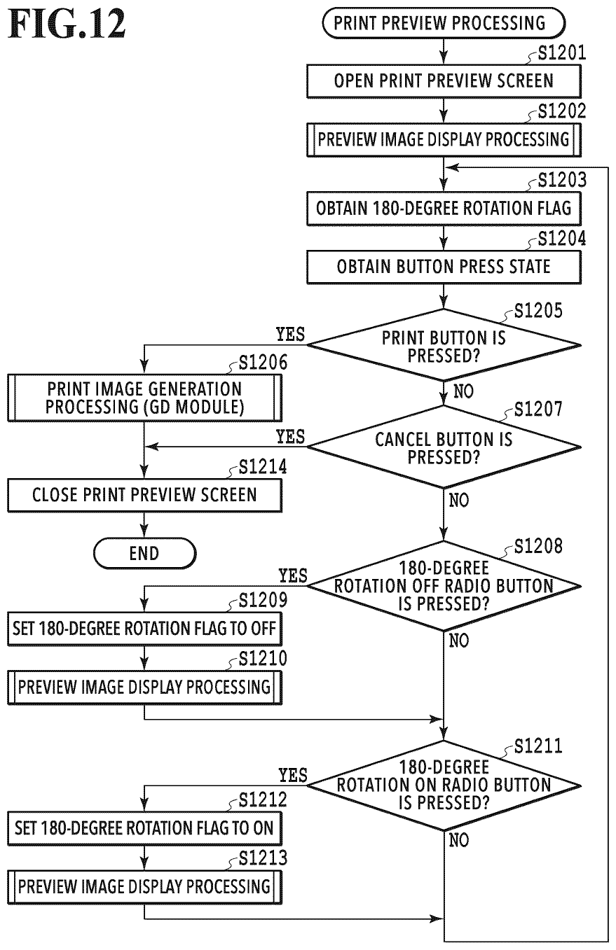

FIG. 12 is a flowchart showing an example of print preview processing by the preview module 209 according to the present embodiment. Each process in this flowchart is implemented by the CPU 111 expanding a program stored in the ROM 112 into the RAM 113 and executing the program. The processing of this flowchart is started by the CPU 111 instructing to start the preview module 209 if the setting for displaying a preview before printing is ON after the spooler 203 loads the print processor 205. Each process in this flowchart is also executed by the CPU 111 functioning as the preview module 209. Therefore, each process is actually performed by the CPU 111, but will be described as being performed by the preview module 209, for ease of understanding.

In S1201, the preview module 209 opens the print preview screen 1101. In S1202, the preview module 209 executes preview image display processing. The preview image display processing will be described in detail later.

In S1203, the preview module 209 obtains the 180-degree rotation flag saved as a print setting. In S1204, the preview module 209 obtains a button press state on the print preview screen 1101.

In S1205, the preview module 209 judges whether the print button 1105 is pressed, by referring to the obtained button press state. If it is judged that the print button 1105 is pressed, the preview module 209 proceeds to S1206. If it is judged that the print button 1105 is not pressed, the preview module 209 proceeds to S1207. In S1206, the preview module 209 instructs the GD module 208 to perform print image generation processing. The print image generation processing will be described in detail later.

In S1207, the preview module 209 judges whether the cancel button 1104 is pressed, by referring to the obtained button press state. If it is judged that the cancel button 1104 is pressed, the preview module 209 proceeds to S1214. If it is judged that the cancel button 1104 is not pressed, the preview module 209 proceeds to S1208. In S1208, the preview module 209 judges whether the 180-degree rotation OFF radio button 1103a is pressed, by referring to the obtained button press state. If it is judged that the 180-degree rotation OFF radio button 1103a is pressed, the preview module 209 proceeds to S1209. If it is judged that the 180-degree rotation OFF radio button 1103a is not pressed, the preview module 209 proceeds to S1211.

In S1209, the preview module 209 saves the 180-degree rotation flag in the print settings with the flag set to OFF. In S1210, the preview module 209 executes the preview image display processing to be described later. In S1211, the preview module 209 judges whether the 180-degree rotation ON radio button 1103b is pressed, by referring to the obtained button press state. If it is judged that the 180-degree rotation ON radio button 1103b is pressed, the preview module 209 proceeds to S1212. If it is judged that the 180-degree rotation ON radio button 1103b is not pressed, the preview module 209 returns to S1203.

In S1212, the preview module 209 saves the 180-degree rotation flag in the print settings with the flag set to ON. In S1213, the preview module 209 executes the preview image display processing to be described later, and then returns to S1203. In S1214, the preview module 209 closes the print preview screen 1101. The preview module 209 then ends the processing of this flowchart.

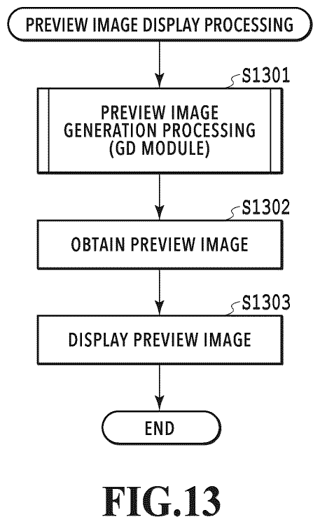

FIG. 13 is a flowchart showing an example of the preview image display processing according to the present embodiment, which is executed by the preview module 209 in S1202, S1210, and S1213 in the flowchart of FIG. 12.

In S1301, the preview module 209 instructs the GD module 208 to perform preview image generation processing. The preview image generation processing will be described in detail later. In S1302, the preview module 209 obtains the preview image 302 generated by the GD module 208. In S1303, the preview module 209 displays the obtained preview image 302 and ends the processing of this flowchart.

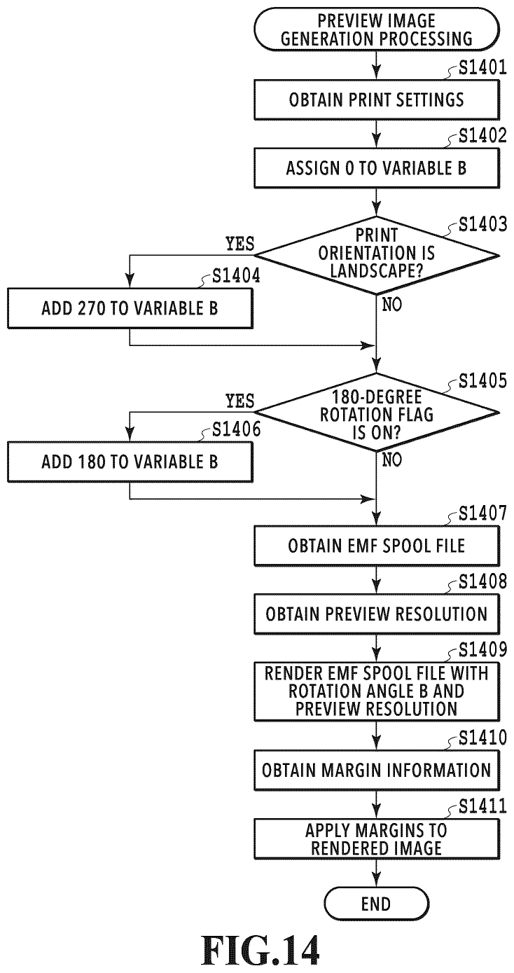

FIG. 14 is a flowchart showing an example of the preview image generation processing executed in S1301 of the flowchart in FIG. 13. Each process in this flowchart is executed by the CPU 111 functioning as the GD module 208. Therefore, each process is actually performed by the CPU 111, but will be described as being performed by the GD module 208, for ease of understanding.

In S1401, the GD module 208 obtains print settings. In S1402, the GD module 208 assigns 0 to a variable B. The variable is a value used in processing and stored in the external storage device 114 or the RAM 113.

In S1403, the GD module 208 judges whether the print orientation is landscape in the obtained print settings. If it is judged that the print orientation is landscape, the GD module 208 proceeds to S1404. If it is judged that the print orientation is not landscape, the GD module 208 proceeds to S1405. In S1404, the GD module 208 adds 270 to the variable B. If the GD module 208 is configured to add 270 to the variable A in S804, the GD module 208 adds 90, instead of 270, to the variable B in this process. In S1405, the GD module 208 judges whether the 180-degree rotation flag is ON in the obtained print settings. If it is judged that the 180-degree rotation flag is ON, the GD module 208 proceeds to S1406. If it is judged that the flag is OFF, the GD module 208 proceeds to S1407.

In S1406, the GD module 208 adds 180 to the variable B. In S1407, the GD module 208 obtains an EMF spool file 301. In S1408, the GD module 208 obtains a preview resolution. The obtained preview resolution may be a fixed value, or may be determined in any manner, such as by making it possible to set the resolution in the print preview screen 1101. However, to quickly display the preview image 1102 on the print preview screen 1101, the preview resolution is preferably lower than the printing resolution.

In S1409, the GD module 208 performs rendering of the EMF spool file 301 in a state where the preview image is rotated counterclockwise by B degrees (the angle of the value of the variable B) at the preview resolution. That is, in this process, the rotation control of the preview image is performed by the GD module 208. The GD module 208 may also be configured to instruct another module to perform rendering, instead of performing the rendering itself. The rendered image data (second image data) is held in the RAM 113 or saved as an image file in the external storage device 114. The image file is deleted after no longer needed.

In S1410, the GD module 208 obtains margin information. The obtained margin information is not margin information that takes into account 180-degree rotation, but margin information that depends on the OS performance. In S1411, the GD module 208 performs editing (image processing) to add margins to the rendered image based on the margin information, and ends the processing of this flowchart.

FIG. 15 is a flowchart showing an example of the print image generation processing executed in S1206 of the flowchart in FIG. 12. The processing of S1501 to S1507 is the same as the processing of S1401 to S1407.

In S1508, the GD module 208 obtains a print resolution. In the present embodiment, the print resolution is determined according to the setting value of the print quality in the print settings. In S1509, the GD module 208 performs rendering of the EMF spool file 301 in a state where the preview image is rotated counterclockwise by B degrees (the angle of the value of the variable B) at the print resolution. The GD module 208 then ends the processing of this flowchart. The image rendered in S1508 is held in the RAM 113 or saved as an image file in the external storage device 114. The image file is deleted after no longer needed.

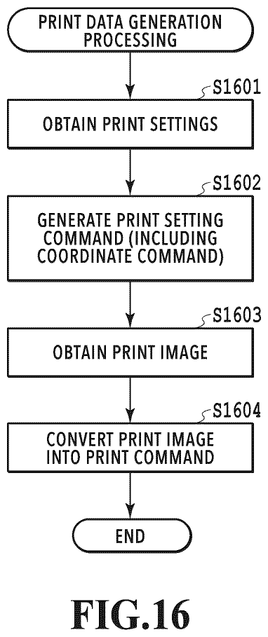

FIG. 16 is a flowchart showing an example of the print data generation processing according to the present embodiment.

The processing of this flowchart is started by the GD module 208 loading the print data generation module 210 and calling the processing of this flowchart after the completion of the processing of the flowchart in FIG. 15. Each process in this flowchart is also executed by the CPU 111 functioning as the print data generation module 210. Therefore, each process is actually performed by the CPU 111, but will be described as being performed by the print data generation module 210, for ease of understanding.

In S1601, the print data generation module 210 obtains print settings. In S1602, the print data generation module 210 generates a control command based on the obtained print settings. The control command is data including command (instruction) information for instructing the printing apparatus 102 to operate. For example, if the setting value of the sheet feeding port in the print settings is “rear tray”, data including instruction information for feeding from the rear tray is generated as a control command. The control command includes a coordinate command for determining at which position on the medium an image command will be drawn by the printing apparatus 102.

In S1603, the print data generation module 210 obtains the print image 303 generated by the GD module 208. In S1604, the print data generation module 210 converts the print image 303 into a print command in a format acceptable by the printing apparatus 102, and ends the processing of this flowchart. After completion of the print data generation processing, the print data 304 is sent to the printing apparatus 102 to perform printing.

Here, description will be given of each process in a case where the print orientation is landscape, unlike FIGS. 9A to 9F.

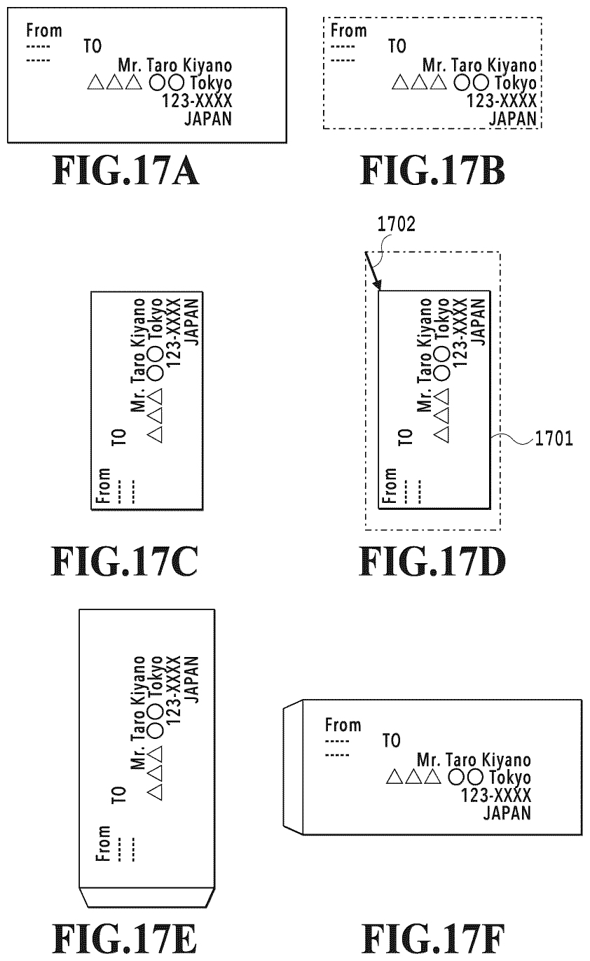

FIGS. 17A to 17F are diagrams schematically showing the drawing contents in each process of the data flow in a case where the 180-degree rotation setting is OFF, the inverse feed medium is selected, and the print orientation is landscape. It is assumed that a long envelope with a flap on the upper side is used as the medium, and that the print button 1105 is pressed in the print preview screen 1101 with the 180-degree rotation ON radio button 1103b selected. In other words, FIGS. 17A to 17F shows an example of a data flow in a case where the user does not change the setting related to the rotation direction in the print preview screen 1101.

FIG. 17A shows manuscript data on the application 204. FIG. 17B shows an EMF spool file 301. The EMF spool file 301 stores drawing information of a printable area excluding margins. In this event, the application 204 is notified of margin information after 270-degree counterclockwise rotation. Specifically, drawing information within the printable area excluding 5 mm on the top (left margin in case of non-rotation), 5 mm on the bottom (right margin in case of non-rotation), 10 mm on the left (bottom margin in case of non-rotation), and 20 mm on the right (top margin in case of non-rotation) is stored.

FIG. 17C shows a print image 303. In this event, rendering is performed by 450-degree counterclockwise rotation in S1509 of the flowchart in FIG. 15.

FIG. 17D shows print data 304. As in FIG. 9D, the print data 304 is obtained by converting the print image 303 into a format acceptable by the printing apparatus 102, and has at least an image command 1701 and a coordinate command 1702 for determining the drawing position of the image command 1701 on the medium.

FIG. 17E shows a printing result formed on the medium by the printing apparatus 102 upon receipt of the print data 304. FIG. 17F shows the printing result rotated counterclockwise 270 degrees from FIG. 17E. The flap is positioned to the left of the print contents. The relative layout matches between FIGS. 17A and 17F.

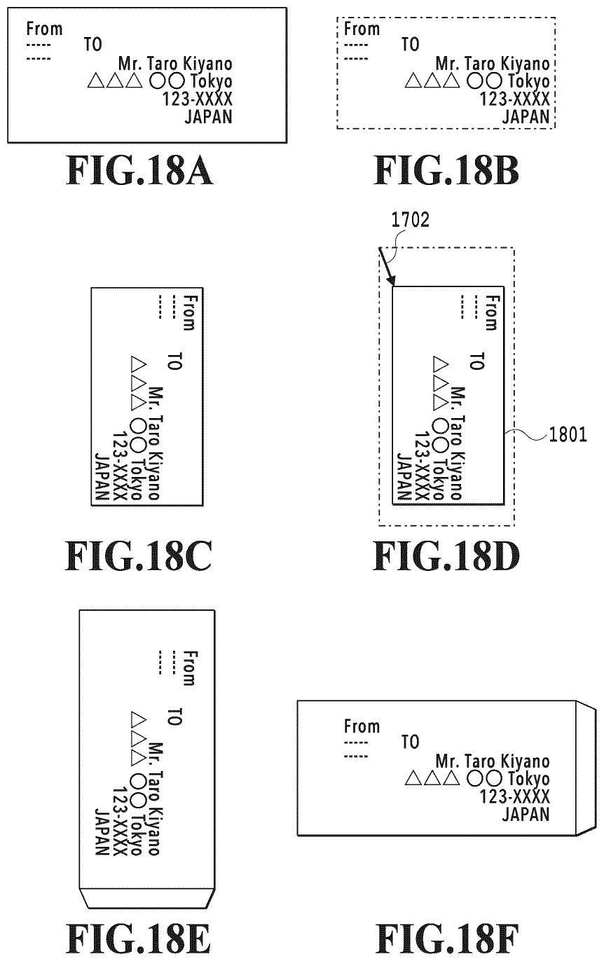

FIGS. 18A to 18F are diagrams schematically showing the drawing contents in each process of the data flow in a case where the print button 1105 is pressed with the 180-degree rotation OFF radio button 1103a selected, instead of the 180-degree rotation ON radio button 1103b, in FIGS. 17A to 17F. In other words, FIGS. 18A to 18F shows an example of a data flow in a case where the user changes the setting related to the rotation direction in the print preview screen 1101.

FIGS. 18A and 18B are the same as FIGS. 17A and 17B, respectively. FIG. 18C shows a print image 303. In this event, rendering is performed by 270-degree counterclockwise rotation in S1509 of the flowchart in FIG. 15. FIG. 18D shows print data 304. An image command 1801 is the same as that shown in FIG. 17D, except that the image command 1801 is generated based on the print image 303 shown in FIG. 18C. That is, compared to FIG. 17D, only the printable area is rotated 180 degrees, and the coordinate command 1702 remains the same.

FIG. 18E shows a printing result formed on the medium by the printing apparatus 102 upon receipt of the print data 304. FIG. 18F shows the printing result rotated counterclockwise 90 degrees from FIG. 18E. The flap is positioned to the right of the print contents. The relative layout does not match between FIGS. 18A and 18F. However, such a case occurs if the 180-degree rotation flag is ON upon start-up of the preview module 209, and the 180-degree rotation OFF radio button 1103a is pressed by the user in the print preview screen 1101. Therefore, the user operation is involved, and the user can check the preview image 1102 in advance on the print preview screen 1101. This makes it possible to avoid the final printing result from being contrary to the user's intention.

Here, description will be given of a situation where loss of print contents occurs in a case where the user changes the setting related to the rotation direction in the print preview screen 1101. Loss of print contents occurs in a case of attempting to match the relative layout between the manuscript data on the application 204 and the print contents formed on the medium (that is, attempting to rotate the entire area of the medium, including the margins, by 180 degrees).

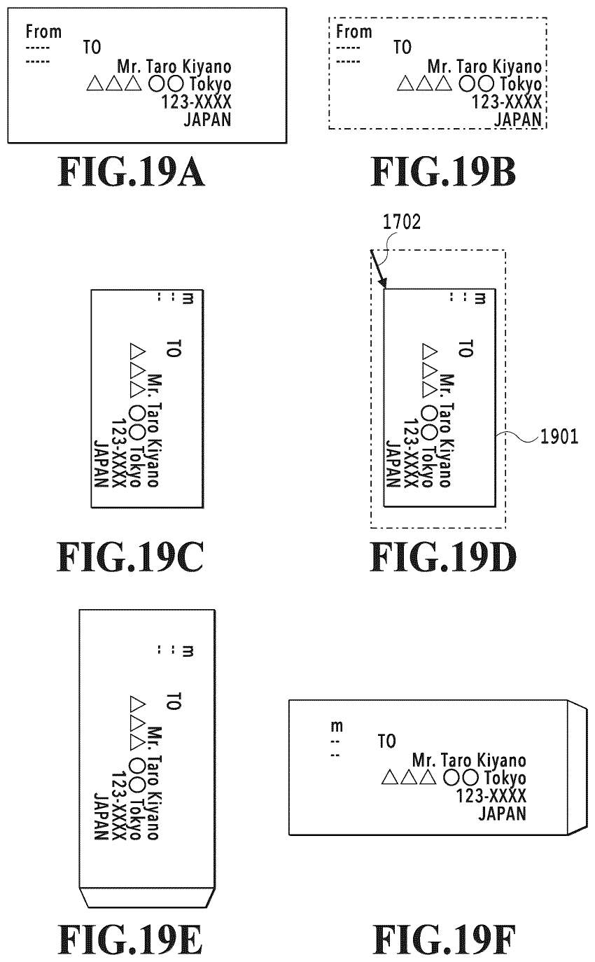

FIGS. 19A to 19F are reference diagrams schematically showing the drawing contents in each step of the data flow in a case of rotating the entire area of the medium, including the margins, by 180 degrees under the conditions shown in FIGS. 18A to 18F.

FIGS. 19A and 19B are the same as FIGS. 18A and 18B, respectively.

In FIG. 18D, compared to FIG. 17D, only the printable area is rotated. On the other hand, to rotate the entire area of the medium including the margins by 180 degrees, the print image 303 needs to be generated taking into account the difference in length between the top and bottom margins. That is, as shown in FIG. 19C, if the top margin is longer than the bottom margin in case of non-rotation, the print image 303 needs to be generated in such a way that the image is moved upward by the difference in length obtained by subtracting the bottom margin from the top margin. If the bottom margin is longer than the top margin, the image needs to be moved downward by the difference in length obtained by subtracting the top margin from the bottom margin. With such a movement, some of the drawing commands stored in the EMF spool file 301 shown in FIG. 19B may be outside the printable area, which may result in loss of print contents.

FIG. 19D shows the print data 304. An image command 1901 is the image command 1301 generated based on the print image 303 shown in FIG. 19C. A coordinate command 1702 in FIG. 19D is the same as that in FIG. 17D. FIG. 19E shows a printing result formed on the medium by the printing apparatus 102 upon receipt of the print data 304. FIG. 19F shows the printing result rotated counterclockwise 90 degrees from FIG. 19E. Although the relative layout matches between FIGS. 19A and 19F, some of the drawing contents in FIG. 19A are missing in FIG. 19F.

Therefore, in a case where the user changes the setting related to the rotation direction in the print preview screen 1101, only the printable area needs to be rotated to avoid the print contents from missing. Since the printing result can be checked in advance on the print preview screen 1101, shifts in print contents that are not intended by the user can be reduced, and unintended printing results can also be reduced.

As described above, according to the present embodiment, the printing result that is not intended by the user can be reduced. Specifically, in a case of portrait mode or landscape mode printing on a medium with a flap, it is possible to reduce a positional shift in the print contents, which is not intended by the user, or loss of print contents caused by rotation of the print contents. This can be achieved by notifying the margin information suited to the medium and by rotating only the printable area in the print preview rotation on the preview screen.

### Embodiment 2

In Embodiment 1, the configuration has been described in which the printable area is rotated 180 degrees if the 180-degree rotation setting is changed in the print preview screen. The configuration such as Embodiment 1 makes it possible to avoid loss of print contents caused by the 180-degree rotation. However, if the 180-degree rotation setting is changed in the print preview screen, the relative layout does not match between the manuscript data on the application 204 and the printing result formed on the medium. Depending on the printing purpose of the user, there are cases where loss of the edges of the print contents is permitted, or manuscript data that will not be lost on the application 204 is created in advance, and the entire area of the medium including the margins is rotated 180 degrees. Therefore, in Embodiment 2, description will be given of a method of providing an interface for selecting between 180-degree rotation of only the printable area or 180-degree rotation of the entire area of the medium including the margins in a case of changing the 180-degree rotation setting in the print preview screen. The present embodiment is the same as Embodiment 1 unless otherwise noted.

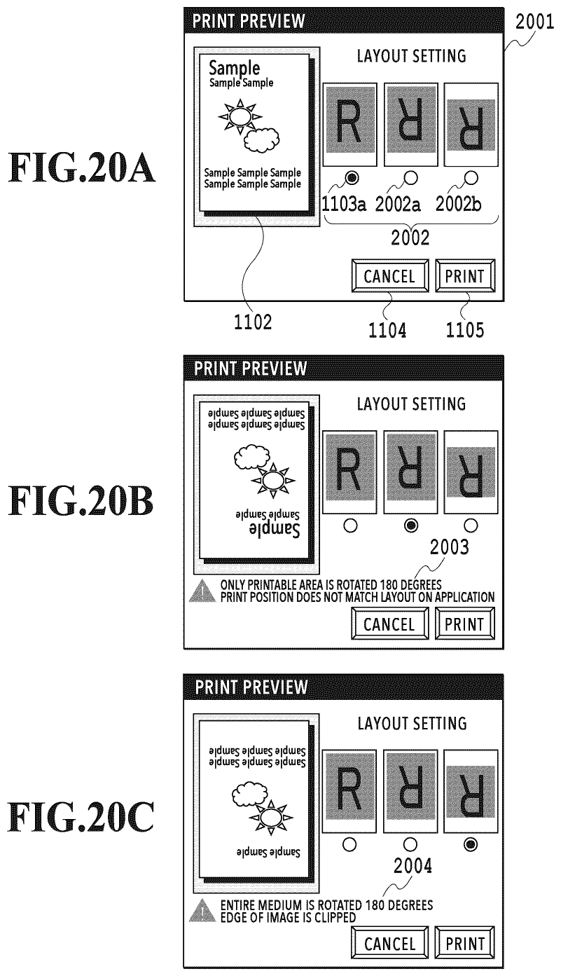

In the present embodiment, a print preview screen shown in FIGS. 20A and 20B are used instead of the print preview screen 1101 shown in FIGS. 11A and 11B. In FIGS. 20A and 20B, the parts denoted by the same reference numerals as those in FIGS. 11A and 11B are the same as in FIGS. 11A and 11B, and thus description thereof will be omitted.

A print preview screen 2001 has a setting interface 2002 for changing the orientation of the print contents. The setting interface 2002 has a 180-degree rotation OFF radio button 1103a, a 180-degree rotation ON radio button A 2002a, and a 180-degree rotation ON radio button B 2002b. In a state where the 180-degree rotation OFF radio button 1103a is selected, a preview image 1102 is displayed in a non-rotated state as shown in FIG. 20A.

FIG. 20B shows the print preview screen in a state where the 180-degree rotation ON radio button A 2002a is selected. As shown in FIG. 20B, the preview image 1102 is displayed as rotated 180 degrees. Specifically, the preview image 1102 of FIG. 20B is obtained by rotating only the printable area of the preview image 1102 in FIG. 20A by 180 degrees.

FIG. 20C shows the print preview screen in a state where the 180-degree rotation ON radio button B 2002b is selected. Unlike FIG. 20B, the preview image 1102 is obtained by rotating the entire area of the medium including the margins of the preview image 1102 in FIG. 20A by 180 degrees.

In the state where the 180-degree rotation ON radio button A 2002a is selected, a layout warning message 2003 is displayed on the print preview screen 2001. The layout warning message 2003 is a message for notifying the user that the relative layout does not match between the manuscript data on the application 204 and the printing result formed on the medium. It is preferable that the layout warning message 2003 is displayed only if the top and bottom margins of the medium do not match or the right and left margins do not match.

In the state where the 180-degree rotation ON radio button B 2002b is selected, a clip warning message 2004 is displayed on the print preview screen 2001. The clip warning message 2004 is a message for notifying the user that there is a possibility of the edge of the print contents missing. It is preferable that the clip warning message 2004 is displayed if the edge of the print contents is actually missing.

By displaying the layout warning message 2003 and the clip warning message 2004, it is possible to further improve the effect of reducing the positional shift in the print contents that is not intended by the user or loss of the print contents caused by the 180-degree rotation. Although the layout warning message 2003 and the clip warning message 2004 are displayed on the print preview screen 2001 in the present embodiment, other display methods may be used, such as opening a separate window to display the messages.

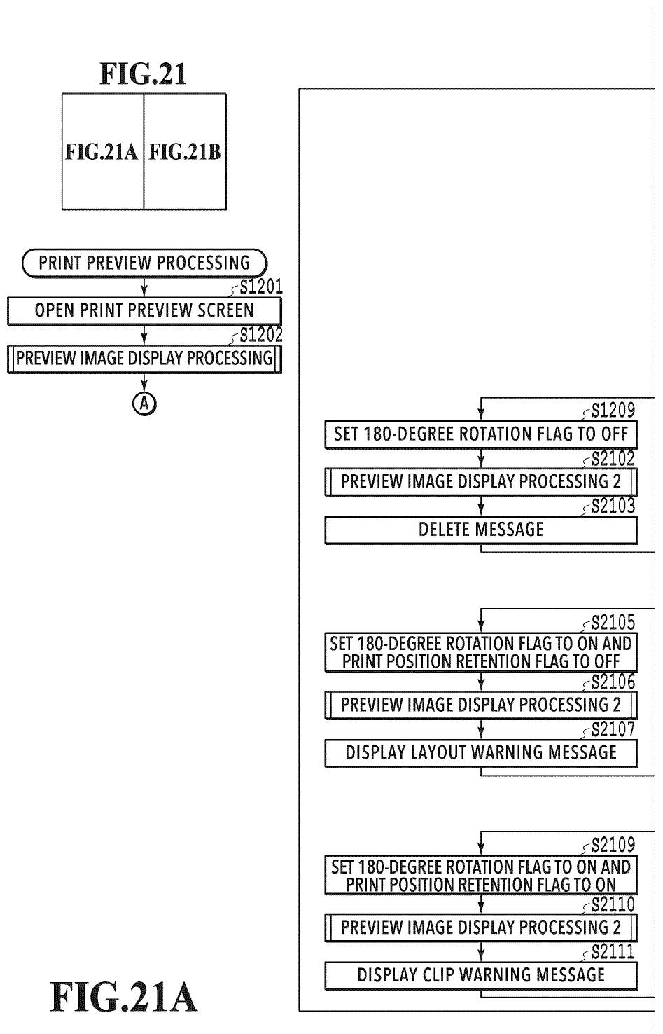

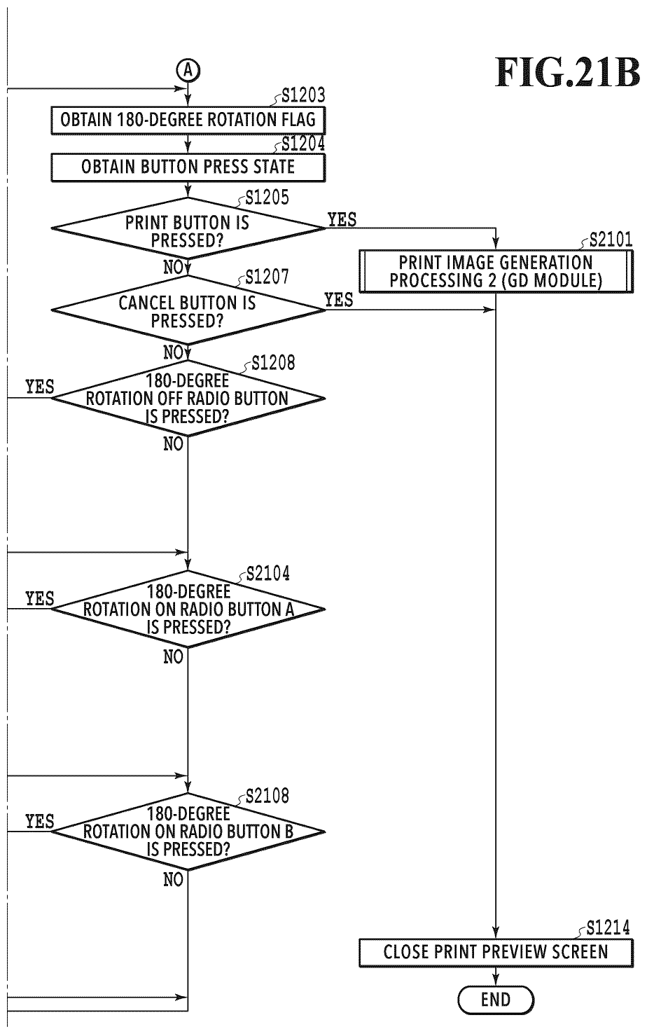

FIG. 21 is a diagram showing the relationship of FIGS. 21A and 21B; FIG. 21A is a diagram showing an example of print preview processing and FIG. 21B is a diagram showing an example of print preview processing. FIGS. 21A and 21B are flowcharts showing an example of print preview processing of the present embodiment by the preview module 209. The print preview processing of the present embodiment is executed according to the flowchart shown in FIGS. 21A and 21B, instead of the flowchart shown in FIG. 12. In FIGS. 21A and 21B, steps denoted by the same reference numerals as those in FIG. 12 are the same as in FIG. 12, and thus description thereof will be omitted.

If the preview module 209 judges in S1205 that the print button 1105 is pressed, the processing proceeds to S2101. In S2101, the CPU 111 instructs the GD module 208 to perform print image generation processing 2. The print image generation processing 2 will be described in detail later.

In S2102, following S1209, the CPU 111 instructs the GD module 208 to perform preview image display processing 2. The preview image display processing 2 will be described in detail later. In S2103, the CPU 111 deletes the layout warning message 2003 or the clip warning message 2004 displayed on the print preview screen 2001.

In S2104, the preview module 209 judges whether the 180-degree rotation ON radio button A 2002a is pressed. If it is judged that the 180-degree rotation ON radio button A 2002a is pressed, the CPU 111 proceeds to S2105. If it is judged that the 180-degree rotation ON radio button A 2002a is not pressed, the CPU 111 proceeds to S2108. In S2105, the CPU 111 saves the 180-degree rotation flag in the print settings with the flag set to ON, and further holds a print position retention flag in the RAM 113 with the flag set to OFF. The print position retention flag is a flag referred to by the GD module 208 to generate the print image 303 or the preview image 302 in the present embodiment. In S2106, the CPU 111 executes the preview image display processing 2 to be described later. In S2107, the CPU 111 displays the layout warning message 2003 on the print preview screen 2001. If the clip warning message 2004 is already displayed, the CPU 111 deletes this message and displays the layout warning message 2003.

In S2108, the CPU 111 judges whether the 180-degree rotation ON radio button B 2002b is pressed. If it is judged that the 180-degree rotation ON radio button B 2002b is pressed, the CPU 111 proceeds to S2109. If it is judged that the 180-degree rotation ON radio button B 2002b is not pressed, the CPU 111 returns to S1203. In S2109, the CPU 111 saves the 180-degree rotation flag in the print settings with the flag set to ON, and also holds the print position retention flag in the RAM 113 with the flag set to ON. In S2110, the CPU 111 executes the preview image display processing 2 to be described later. In S2111, the CPU 111 displays the clip warning message 2004 on the print preview screen 2001. If the layout warning message 2003 is already displayed, the CPU 111 deletes this message and displays the clip warning message 2004. The CPU 111 then returns to S1203.

The print image generation processing 2 is the same as the print image generation processing shown in FIG. 15 in Embodiment 1, except for including processing described below. The preview image display processing 2 is the same as the preview image display processing shown in FIG. 13 in Embodiment 1, except for including processing described below.

In the print image generation processing 2 or the preview image display processing 2, the GD module 208 generates the print image 303 or the preview image 302. In this event, if the print position retention flag is OFF, which is the flag for retaining the print position from the manuscript data on the application 204, the GD module 208 rotates the drawing content without changing its position in a case of rendering by rotation. In other words, the GD module 208 rotates only the printable area by 180 degrees.

On the other hand, if the print position retention flag is ON, the GD module 208 rotates the drawing content after changing the coordinates of the drawing command so that the entire area of the medium, including the margins, is rotated in a case of rendering by rotation. For example, in a case of 180-degree rotation with the top margin of 20 mm and the bottom margin of 10 mm, the coordinates of the drawing command are changed upward by 10 mm, which is the difference between the top margin and the bottom margin, and then rendering is performed by 180-degree rotation. Accordingly, the relative layout matches between the manuscript data on the application 204 and the printing result formed on the medium. However, as described above, there is a possibility that the edge of the image data may be missing during rendering due to the change in the coordinates of the drawing command.

In addition to the effects described in Embodiment 1, the present embodiment described above has the following effects. Specifically, in a case of changing the 180-degree rotation setting in the print preview screen, the user can select whether to match the relative layout between the manuscript data on the application and the printing result formed on the medium, or to avoid the edge of the print contents from missing. By also displaying a warning message in response to the selected state described above, the effect of reducing the positional shift in the print contents that is not intended by the user or the loss of the print contents can be further enhanced. This makes it possible to reduce the printing result that is not intended by the user.

### Other Embodiments

The various controls described above as being performed by the CPU may be performed by a single piece of hardware, or the entire apparatus may be controlled by a plurality of pieces of hardware (for example, a plurality of processors or circuits) sharing the processing.

The present disclosure has been described in detail based on the preferred embodiments, but the present disclosure is not limited to these specific embodiments, and also includes various embodiments without departing from the gist of the present disclosure. The embodiments described above each merely shows one embodiment of the present disclosure, and may be combined as appropriate.

The present disclosure can also be implemented by processing in which a program for implementing one or more functions of the above embodiments is supplied to a system or an apparatus via a network or a storage medium, and one or more processors in a computer of the system or apparatus read and execute the program. The present disclosure can also be implemented by a circuit (for example, ASIC) for implementing one or more functions.

As described above, the present disclosure makes it possible to reduce the printing result that is not intended by the user.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-147961, filed Aug. 29, 2024, which is hereby incorporated by reference herein in its entirety.

What is claimed is:

1. A non-transitory computer readable storage medium storing a program for executing printing using manuscript data generated by an application, which functions in an information processing apparatus and causes the information processing apparatus to function as:
a notification unit configured to notify the application of margin information obtained by rotating margins applied to the manuscript data by 180 degrees, based on a first condition;
an obtaining unit configured to obtain first image data obtained by applying the margin information to the manuscript data generated by the application;
a display control unit configured to rotate the first image data by 180 degrees based on the first condition and to display the first data as second image data on a preview screen; and
a rotation control unit configured to rotate a printable area of the displayed second image data by 180 degrees based on a second condition in the preview screen.

2. The storage medium according to claim 1, wherein
the first image data is image data indicating a printable area of the manuscript data to which the margin information is applied.

3. The storage medium according to claim 1, wherein
the printable area is an area of the image data excluding the margins.

4. The storage medium according to claim 1, wherein
the first condition is that a flag for rotating print contents of the manuscript data by 180 degrees is enabled.

5. The storage medium according to claim 4, wherein
the obtaining unit further obtains print settings for the manuscript data, and
the flag is enabled if either one of the following is satisfied: a specific sheet type is selected in the print settings, or a 180-degree rotation setting is ON in the print settings.

6. The storage medium according to claim 1, wherein
the second condition is that a first button for rotating the second image data displayed in the preview screen is pressed.

7. The storage medium according to claim 6, wherein
the display control unit further displays a second button for rotating the second image data in the preview screen, and
the rotation control unit rotates an entire area of the displayed second image data by 180 degrees if the second button is pressed.

8. The storage medium according to claim 7, wherein
pressing of the first button or the second button can be selected by a user's operation, and
the rotation control unit rotates the displayed second image data by 180 degrees in accordance with the user's selection.

9. The storage medium according to claim 8, wherein
if the first button is pressed in the preview screen, a warning is displayed to the effect that relative print positions do not match between the manuscript data displayed in the application and the second image data.

10. The storage medium according to claim 8, wherein
if the second button is pressed in the preview screen, a warning is displayed to the effect that there is a possibility of print contents missing.

11. The storage medium according to claim 5, wherein
if a print orientation is set to landscape in the print settings,
the notification unit notifies the application of margin information obtained by further rotating margins set in the manuscript data by 90 degrees or 270 degrees.

12. The storage medium according to claim 1, further causing the information processing apparatus to function as:
an output unit configured to add a command including margins to the second image data displayed on the preview screen and to output print data.

13. The storage medium according to claim 5, wherein
the flag is enabled if a specific sheet type is selected in the print settings, and the specific sheet type is a sheet having a flap.

14. The storage medium according to claim 13, wherein
the specific sheet type is a long envelope.

15. An information processing apparatus, comprising at least one memory and at least one processor and/or at least one circuit which functions as:
a notification unit configured to notify an application of margin information obtained by rotating margins set in manuscript data by 180 degrees, based on a first condition;
an obtaining unit configured to obtain first image data obtained by applying the margin information to the manuscript data generated by the application;
a display control unit configured to rotate the first image data by 180 degrees based on the first condition and to display the first data as second image data on a preview screen; and
a rotation control unit configured to rotate a printable area of the displayed second image data by 180 degrees based on a second condition in the preview screen.

16. A method for controlling an information processing apparatus, comprising:
notifying an application of margin information obtained by rotating margins set in manuscript data by 180 degrees, based on a first condition;
obtaining first image data obtained by applying the margin information to the manuscript data generated by the application;
performing display control to rotate the first image data by 180 degrees based on the first condition and to display the first data as second image data on a preview screen; and
performing rotation control to rotate a printable area of the displayed second image data by 180 degrees based on a second condition in the preview screen.
